(19) United States
(12) Patent Application Publication
(10) Pub. No.: US 2023/0387401 A1
(43) Pub. Date: Nov. 30, 2023

(54) NEGATIVE ELECTRODE AND ZINC SECONDARY BATTERY

(71) Applicant: NGK INSULATORS, LTD., Nagoya-shi (JP)

(72) Inventors: Hiroshi HAYASHI, Konan-city (JP); Hiroshi MATSUBAYASHI, Suzuka-City (JP); Sota SHIMIZU, Nagoya-shi (JP)

(21) Appl. No.: 18/361,959

(22) Filed: Jul. 31, 2023

Related U.S. Application Data
(63) Continuation of application No. PCT/JP2021/042438, filed on Nov. 18, 2021.

(30) Foreign Application Priority Data
Mar. 15, 2021 (JP) 2021-041873

(51) Int. Cl. H01M 4/42; H01M 4/04; H01M 10/0585

(52) U.S. Cl. CPC H01M 4/42; H01M 4/0435; H01M 10/0585; H01M 2004/021

(57) ABSTRACT

Provided is a negative electrode for use in a zinc secondary battery, including a negative electrode active material layer having a first surface and a second surface, and a negative electrode current collector plate embedded in the negative electrode active material layer parallel to the negative electrode active material layer. The first surface of the negative electrode active material layer is more remote from the negative electrode current collector plate than the second surface, whereby the center of the negative electrode active material layer in a thickness direction is deviated from a reference plane passing through the center of the negative electrode current collector plate in a thickness direction. A ratio of a thickness defined as a distance between the second surface and the reference plane to a thickness defined as a distance between the first surface and the reference plane is greater than 0 and 0.5 or less.

### CROSS-REFERENCE TO RELATED APPLICATIONS

This application is a continuation application of PCT/JP2021/042438 filed Nov. 18, 2021, which claims priority to Japanese Patent Application No. 2021-041873 filed Mar. 15, 2021, the entire contents all of which are incorporated herein by reference.

### BACKGROUND OF THE INVENTION

### 1. Field of the Invention

The present invention relates to a negative electrode and a zinc secondary battery.

### 2. Description of the Related Art

In zinc secondary batteries such as nickel-zinc secondary batteries, air-zinc secondary batteries, etc., metallic zinc precipitates from a negative electrode in the form of dendrites upon charging, and penetrates into voids of a separator such as a nonwoven fabric and reaches a positive electrode, which is known to result in bringing about short-circuiting. The short circuit due to such zinc dendrites shortens the life in repeated charge/discharge cycles.

In order to deal with the above issues, batteries comprising layered double hydroxide (LDH) separators that prevent penetration of zinc dendrites while selectively permeating hydroxide ions, have been proposed. For example, Patent Literature 1 (WO2013/118561) discloses that an LDH separator is provided between a positive electrode and a negative electrode in a nickel-zinc secondary battery. Moreover, Patent Literature 2 (WO2016/076047) discloses a separator structure comprising an LDH separator fitted or joined to a resin outer frame, and discloses that the LDH separator has a high density to the degree that it has gas impermeability and/or water impermeability. Moreover, this literature also discloses that the LDH separator can be composited with porous substrates. Further, Patent Literature 3 (WO2016/067884) discloses various methods for forming an LDH dense membrane on a surface of a porous substrate to obtain a composite material. This method comprises steps of uniformly adhering a starting material that can impart a starting point for LDH crystal growth to a porous substrate and subjecting the porous substrate to hydrothermal treatment in an aqueous solution of raw materials to form the LDH dense membrane on the surface of the porous substrate. An LDH separator in which further denseness was realized by roll pressing a composite material of an LDH/porous substrate fabricated via hydrothermal treatment, has also been proposed. For example, Patent Literature 4 (WO2019/124270) discloses an LDH separator that includes a polymer porous substrate and an LDH filled into the porous substrate, and has a linear transmittance of 1% or more at a wavelength of 1,000 nm.

Moreover, LDH-like compounds have been known as hydroxides and/or oxides with a layered crystal structure that cannot be called LDH but are analogous thereto, which exhibit hydroxide ion conductive properties similar to those of a compound to an extent that it can be collectively referred to as layered hydroxide ion conductive compounds together with LDH. For example, Patent Literature 5 (WO2020/255856) discloses a hydroxide ion conductive separator containing a porous substrate and a layered double hydroxide (LDH)-like compound that clogs up pores in the porous substrate, wherein this LDH-like compound is a hydroxide and/or oxide with a layered crystal structure including Mg and one or more elements selected from the group consisting of Ti, Y, and Al and including at least Ti. This hydroxide ion conductive separator is said to have superior alkali resistance and to enable inhibition of a short circuit due to zinc dendrites more effectively than conventional LDH separators.

By the way, a negative electrode in a zinc secondary battery includes a negative electrode active material layer and a negative electrode current collector plate. For example, Patent Literature 6 (JP2020-170652A) discloses a negative electrode for a zinc battery comprising a negative electrode current collector, a first negative electrode material layer (including a negative electrode active material) provided on one side of the negative electrode current collector, and a second negative electrode material layer (including a negative electrode active material) provided on the other side of the negative electrode current collector. This negative electrode has a ratio of a thickness of the second negative electrode material layer to a thickness of the first negative electrode material layer of 0.7 to 1, and a difference in thicknesses between the two is small. Such a configuration is said to make it possible to inhibit ZnO from unevenly depositing on one of the negative electrode material layers and thereby to smoothly transfer OH⁻ to and from a positive electrode facing the negative electrode, resulting in improvement of life performance of the zinc battery.

### CITATION LIST

### Patent Literature

Patent Literature 1: WO2013/118561

Patent Literature 2: WO2016/076047

Patent Literature 3: WO2016/067884

Patent Literature 4: WO2019/124270

Patent Literature 5: WO2020/255856

Patent Literature 6: JP2020-170652A

### SUMMARY OF THE INVENTION

However, the charge/discharge cycle performance of conventional zinc secondary batteries is not always sufficient, thereby requiring its further improvement.

The present inventors have now found that a cycle life of a zinc secondary battery can be prolonged by disposing a negative electrode active material layer at a thickness ratio to give an asymmetry with respect to a negative electrode collector plate so that the center of the negative electrode active material layer in a thickness direction thereof is deviated from a reference plane passing through the center of a negative electrode collector plate in a thickness direction thereof.

Therefore, an object of the present invention is to provide a negative electrode capable of prolonging the cycle life of a zinc secondary battery.

According to an aspect of the present invention, there is provided a negative electrode for use in a zinc secondary battery, comprising:
a negative electrode active material layer comprising at least one selected from the group consisting of zinc, zinc oxide, a zinc alloy, and a zinc compound, and having a first surface and a second surface,
a negative electrode current collector plate embedded in the negative electrode active material layer parallel to the negative electrode active material layer,
wherein the first surface is more remote from the negative electrode current collector plate than the second surface, whereby the center of the negative electrode active material layer in a thickness direction thereof is deviated from a reference plane passing through the center of the negative electrode current collector plate in a thickness direction thereof, and
wherein a ratio of a thickness T₂ defined as a distance between the second surface and the reference plane to a thickness T₁, defined as a distance between the first surface and the reference plane, T₂/T₁, is greater than 0 and 0.5 or less.

According to another aspect of the present invention, there is provided a zinc secondary battery comprising
a positive electrode comprising a positive electrode active material layer and a positive electrode current collector,
the negative electrode,
a hydroxide ion conductive separator separating the positive electrode from the negative electrode so as to be capable of conducting hydroxide ions therethrough,
an electrolytic solution;
wherein the negative electrode is disposed so that the second surface is a side closer to the hydroxide ion conductive separator.

### BRIEF DESCRIPTION OF THE DRAWINGS

FIG. 1 is a schematic cross-sectional view of an example of the negative electrode according to the present invention.

FIG. 2 is a view conceptually illustrating a migration path of hydroxide ions (OH⁻) until they reach a surface of a negative electrode current collector plate in a conventional negative electrode.

FIG. 3 is a view conceptually illustrating a migration path of hydroxide ions (OH⁻) until they reach a surface of a negative electrode current collector plate in the negative electrode of the present invention.

FIG. 4 is a cross-sectional photograph of the negative electrode fabricated in Example 1 (comparison) (after charge/discharge evaluation).

FIG. 5 is a cross-sectional photograph of the negative electrode fabricated in Example 4 (after charge/discharge evaluation).

### DETAILED DESCRIPTION OF THE INVENTION

Negative Electrode

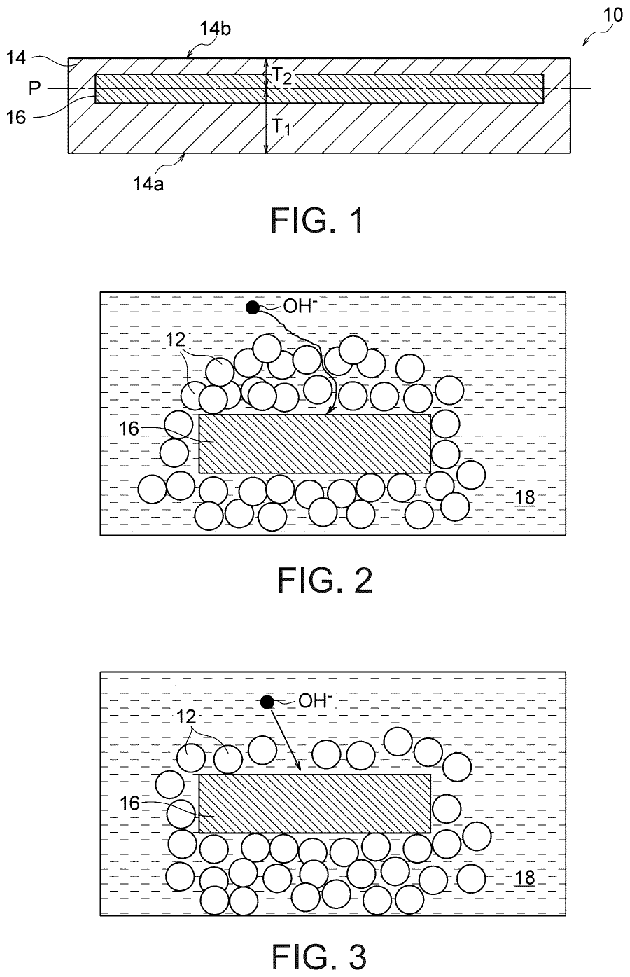

The negative electrode of the present invention is a negative electrode for use in a zinc secondary battery. FIG. 1 shows one aspect of the negative electrode according to the present invention. A negative electrode 10 shown in FIG. 1 comprises a negative electrode active material layer 14 and a negative electrode current collector plate 16. Negative electrode active material layer 14 includes at least one selected from the group consisting of zinc, zinc oxide, a zinc alloy, and a zinc compound. Negative electrode active material layer 14 has a first surface 14a and a second surface 14b. Negative electrode current collector plate 16 is embedded in negative electrode active material layer 14 parallel to negative electrode active material layer 14. First surface 14a of negative electrode active material layer 14 is more remote from negative electrode current collector plate 16 than second surface 14b, whereby the center of negative electrode active material layer 14 in a thickness direction thereof is deviated from a reference plane P passing through the center of negative electrode current collector plate 16 in a thickness direction thereof. In other words, negative electrode active material layer 14 is asymmetrically disposed with respect to negative electrode current collector plate 16. In particular, a ratio of a thickness T₂ defined as a distance between second surface 14b of negative electrode active material layer 14 and reference plane P to a thickness T₁ defined as a distance between first surface 14a of negative electrode active material layer 14 and reference plane P, T₂/T₁, is greater than 0 and 0.5 or less. In this way, disposition of negative electrode active material layer 14 at a thickness ratio to give an asymmetry with respect to negative electrode current collector plate 16 so that the center of negative electrode active material layer 14 in the thickness direction is deviated from reference plane P passing through the center of negative electrode current collector plate 16 in the thickness direction, enables prolongation of a cycle life of a zinc secondary battery.

This prolongation effect of the cycle life is considered to be due to improvements of ion conductivity and reactivity at and in the vicinity of negative electrode 10 because of the unique asymmetric disposition described above. Namely, according to the knowledge of the present inventors, a conventional negative electrode in which a negative electrode active material layer is disposed to have equal thickness ratios for each of both sides of a negative electrode current collector plate, has a higher resistance in a battery reaction than a negative electrode not having equal thickness ratios. This conjectured mechanism is surmised as follows. That is, as exemplified in FIG. 2, in the conventional negative electrode, negative electrode active materials 12 (constituting negative electrode active material layers 14) are evenly present in the circumference of negative electrode current collector plate 16. Therefore, in order for hydroxide ions (OH⁻) present in an electrolytic solution 18, which are necessary for a charge/discharge reaction in the negative electrode to reach a surface of negative electrode current collector plate 16, the hydroxide ions are required to weave and circumvent their ways through the numerous gaps between negative electrode active materials 12, as the migration path indicated by the arrow in the figure. Such a long migration distance of hydroxide ion in the conventional negative electrode increases a reaction resistance and loses a discharging capacity. Accordingly, a discharging reaction will complete while negative electrode active material 12 has not completely been changed. When the next charge is carried out in such a condition, an excess capacity is charged, causing irreversible side reactions or the like. As a result, the number of times that charge/discharge can be performed is considered to be reduced. In negative electrode 10 of the present invention, on the other hand, negative electrode active material layer 14 is asymmetrically disposed with respect to negative electrode current collector plate 16 as described above. In other words, as exemplified in FIG. 3, the amount of negative electrode active material 12 on one side of negative electrode current collector plate 16 (the side closer to second surface 14b of negative electrode active material layer 14) is small. Therefore, hydroxide ions (OH⁻) can reach the surface of negative electrode current collector plate 16 in a linear manner, as the migration path indicated by the arrow in the figure. Namely, in negative electrode 10 of the present invention, a resistance in a battery reaction can be reduced as a result of the shorter migration distances of hydroxide ions. Therefore, it is surmised that ion conductivity and reactivity improve in a zinc secondary battery, thereby enabling prolongation of a cycle life.

In negative electrode 10, T₂/T₁, which is the ratio of thickness T₂ to thickness T₁, is greater than 0 and 0.5 or less, preferably greater than 0 and 0.2 or less, and more preferably 0.01 to 0.1. As described above, such a way improves ion conductivity and reactivity in a zinc secondary battery, and can prolong the cycle life. Thickness T₁ is defined as a distance between first surface 14a of negative electrode active material layer 14 and reference plane P, as described above. Thickness T₂ is also defined as a distance between second surface 14b of negative electrode active material layer 14 and reference plane P. Therefore, measurements of thickness T₁ and thickness T₂ may be made by cutting out and observing a cross-section of negative electrode 10, setting reference plane P so as to pass through the center of negative electrode current collector plate 16 in the thickness direction thereof, and then measuring distances from both sides (outermost surface) of negative electrode active material layer 14 to reference plane P, respectively. In this case, it goes without saying that the surface of negative electrode active material layer 14 having a longer distance to reference plane P becomes first surface 14a, and the surface of negative electrode active material layer 14 having a shorter distance to reference plane P becomes second surface 14b.

Negative electrode 10 preferably has a difference between thickness T₁ and thickness T₂ of 0.01 mm or more, more preferably 0.04 to 2.0 mm, further preferably 0.10 to 2.0 mm, and particularly preferably 0.20 to 2.0 mm. In this manner, ion conductivity and reactivity can be more effectively improved in a zinc secondary battery, and the cycle life can be further prolonged.

Thickness T₂ is preferably 0.01 to 1.0 mm, more preferably 0.01 to 0.9 mm, further preferably 0.01 to 0.6 mm, and particularly preferably 0.01 to 0.3 mm. With such thicknesses, hydroxide ions (OH⁻) can more linearly reach a surface of negative electrode current collector plate 16, and a resistance in a battery reaction can be further reduced. Thickness T₁, on the other hand, may be greater than thickness T₂ so that the above ratio T₂/T₁ is satisfied, and its value is not particularly limited, but is typically 0.02 to 2.0 mm, more typically 0.10 to 2.0 mm, and further typically 0.30 to 2.0 mm.

Negative electrode 10 includes negative electrode active material layer 14. Negative electrode active material 12 constituting negative electrode active material layer 14 contains at least one selected from the group consisting of zinc, zinc oxide, zinc alloys, and zinc compounds. Zinc may be contained in any form of a zinc metal, zinc compound, or zinc alloy, as long as it has electrochemical activity suitable for the negative electrode. Preferred examples of the negative electrode materials include zinc oxide, zinc metals, calcium zincate, and the like, but a mixture of a zinc metal and zinc oxide is more preferred. Negative electrode active material 12 may have a gel-like configuration or may be mixed with electrolytic solution 18 to form a negative electrode mixture. For example, a negative electrode that underwent gelation can be easily obtained by adding an electrolytic solution and a thickening agent to negative electrode active material 12. Examples of thickening agents include a polyvinyl alcohol, polyacrylate, CMC, alginic acid, and the like, and the polyacrylic acid is preferred because of its excellent chemical resistance to strong alkalis.

A zinc alloy containing no mercury and lead, known as a mercury-freed zinc alloy, can be used. For example, a zinc alloy containing 0.01 to 0.1% by mass indium, 0.005 to 0.02% by mass bismuth, and 0.0035 to 0.015% by mass aluminum is preferred because it has an inhibition effect of hydrogen gas generation. In particular, indium and bismuth are advantageous in terms of improving discharge performance. Use of zinc alloys in the negative electrode inhibits hydrogen gas generation by lowering a self-dissolution rate in an alkaline electrolytic solution, thereby enabling safety improvement.

A shape of the negative electrode material is not particularly limited, but is preferably in powder form, which thereby increases a surface area and allows for large current discharge. In the case of a zinc alloy, an average particle size of a preferred negative electrode material is in a range of 3 to 100 μm in short diameter, and within this range, a surface area becomes large, which is therefore suitable for large current discharge and facilitates homogeneous mixing with an electrolytic solution and gelling agent and also provides favorable handleability upon battery assembly.

Negative electrode 10 includes negative electrode current collector plate 16 that is embedded in parallel to negative electrode active material layer 14. Negative electrode current collector plate 16 is a platy current collector and therefore has a desired thickness. Negative electrode current collector plate 16 that is a metal plate having a plurality of (or many) apertures, is preferably used from the viewpoint of active material adhesiveness. Preferred examples of such negative electrode current collector plate 16 include an expanded metal, punching metal, metal mesh, and combinations thereof, more preferably a copper expanded metal, copper punching metal, and combinations thereof, and particularly preferably a copper expanded metal. In this case, for example, a negative electrode active material sheet composed of zinc oxide and/or zinc powder and a binder (for example, polytetrafluoroethylene particles) if desired, is compressed and bonded onto a copper expanded metal to preferably enable fabrication of a negative electrode composed of a negative electrode active material layer/negative electrode current collector plate. In this course, the ratio T₂/T₁ can be controlled by compressing and bonding each negative electrode active material sheet of different thickness on both sides of the copper expanded metal. Note, however, the expanded metal is a mesh-shaped metal sheet such that a metal plate is spread out by a machine for manufacturing expanded metals while making staggered cuts, and the cuts are formed into diamond shapes or hexagonal shapes. The punching metal is also called a perforated metal, and such that a metal plate with holes is made by a perforation process. The metal mesh is a metal product with a wire mesh structure, which is different from the expanded metal and punching metal.

Zinc Secondary Battery

Negative electrode 10 of the present invention is preferably applied to a zinc secondary battery. Therefore, according to a preferred aspect of the present invention, there is provided a zinc secondary battery comprising a positive electrode including a positive electrode active material layer and a positive electrode current collector, negative electrode 10, a hydroxide ion conductive separator separating the positive electrode from negative electrode 10 so as to be capable of conducting hydroxide ions therethrough, and electrolytic solution 18. In this zinc secondary battery, negative electrode 10 is disposed so that second surface 14b of negative electrode active material layer 14 is the side closer to the hydroxide ion conductive separator. With such a disposition, the amount of negative electrode active material 12 present between negative electrode current collector plate 16 and the hydroxide ion conductive separator is reduced. Therefore, hydroxide ions that have permeated the hydroxide ion conductive separator can quickly reach the surface of negative electrode collector plate 16, thus enabling reduction of the reaction resistance and prolongation of a cycle life.

The zinc secondary battery of the present invention is not particularly limited as long as it is a secondary battery using the aforementioned negative electrode 10 and electrolytic solution 18 (typically an alkali metal hydroxide aqueous solution). Therefore, it can be a nickel-zinc secondary battery, silver oxide-zinc secondary battery, manganese oxide-zinc secondary battery, zinc-air secondary battery, and various other alkaline zinc secondary batteries. For example, a positive electrode active material layer contains nickel hydroxide and/or nickel oxyhydroxide, whereby a zinc secondary battery preferably forms a nickel-zinc secondary battery. Alternatively, a positive electrode material layer is an air electrode layer, whereby a zinc secondary battery may form a zinc-air secondary battery.

The hydroxide ion conductive separator is not particularly limited as long as it is a separator that can separate the positive electrode from negative electrode 10 so as to be capable of conducting hydroxide ions therethrough, and typically a separator that contains a hydroxide ion conductive solid electrolyte and selectively passes hydroxide ions by exclusively utilizing hydroxide ion conductivity. A preferred hydroxide ion conductive solid electrolyte is a layered double hydroxide (LDH) and/or LDH-like compound. Therefore, the hydroxide ion conductive separator is preferably an LDH separator. The “LDH separator” as used herein is defined as a separator containing LDH and/or an LDH-like compound and as that selectively passing hydroxide ions by exclusively utilizing the hydroxide ion conductivity of the LDH and/or LDH-like compound. The “LDH-like compound” herein, although it may not be called an LDH, is hydroxide and/or oxide with a layered crystal structure analogous to LDH, and can be considered as an equivalent of LDH. In a broader definition, however, “LDH” can also be interpreted to include not only LDH but also the LDH-like compound. The LDH separator is preferably composited with a porous substrate. Thus, it is preferred that the LDH separator further includes a porous substrate, and that an LDH and/or LDH-like compound is composited with the porous substrate in a form of being filled in pores of the porous substrate. Namely, a preferred LDH separator is a separator in which an LDH and/or LDH-like compound clog up pores of the porous substrate so that the separator exhibits hydroxide ion conductivity and gas impermeability (and thus functions as an LDH separator that exhibits hydroxide ion conductivity). The porous substrate is preferably made of polymeric material, and the LDH is particularly preferably incorporated over the entire region of the porous substrate made of polymeric material in the thickness direction. For example, known LDH separators such as those disclosed in Patent Literatures 1 to 5 can be used. A thickness of the LDH separator is preferably from 3 to 80 μm, more preferably from 3 to 60 μm, and further preferably from 3 to 40 μm.

The electrolytic solution 18 preferably comprises an alkali metal hydroxide aqueous solution. The alkali metal hydroxide includes, for example, potassium hydroxide, sodium hydroxide, lithium hydroxide, ammonium hydroxide, etc., however, potassium hydroxide is more preferred. Zinc oxide, zinc hydroxide, etc., may be added to the electrolytic solution in order to inhibit spontaneous dissolution of the zinc-containing material.

LDH-Like Compound

According to a preferred aspect of the present invention, the LDH separator can be such that it contains an LDH-like compound; the definition of the LDH-like compound is as described above. A preferred LDH-like compound is as follows:
(a) Hydroxide and/or oxide with a layered crystal structure containing Mg and one or more elements with at least T₁, selected from the group consisting of T₁, Y, and Al; or
(b) hydroxide and/or oxide with a layered crystal structure containing (i) T₁, Y, and optionally Al and/or Mg and (ii) an additive element M that is at least one type selected from the group consisting of In, Bi, Ca, Sr and Ba; or
(c) hydroxide and/or oxide with a layered crystal structure containing Mg, Ti Y, and optionally Al and/or In, wherein the LDH-like compound is present in the form of a mixture with In(OH)₃ in (c).

According to the preferred aspect (a) of the present invention, the LDH-like compound can be hydroxide and/or oxide with a layered crystal structure containing Mg and one or more elements with at least Ti, selected from the group consisting of Ti, Y, and Al. Thus, a typical LDH-like compound is complex hydroxide and/or complex oxide of Mg, Ti, optionally Y, and optionally Al. The aforementioned elements may be replaced by other elements or ions to the extent that the basic characteristics of the LDH-like compound are not impaired; however, the LDH-like compound is preferably free of Ni. For example, the LDH-like compound may be such that it further contains Zn and/or K. This can further improve the ionic conductivity of the LDH separator.

The LDH-like compound can be identified by X-ray diffraction. Specifically, when an LDH separator undergoes X-ray diffraction on its surface, a peak derived from the LDH-like compound is typically detected in the range of 5°≤2θ≤10° and more typically in the range of 7°≤2θ≤10°. As described above, LDH is a substance with an alternating stacked structure in which exchangeable anions and H₂O are present as an intermediate layer between the stacked hydroxide base layers. In this regard, when an LDH is measured by an X-ray diffraction method, a peak (i.e., the (003) peak of LDH) is essentially detected at the position of 2θ=11 to 12° derived from a crystal structure of LDH. When the LDH-like compound is measured by the X-ray diffraction method, on the contrary, a peak is typically detected in the range described above that is shifted to the lower angle side than the position of the aforementioned peak of LDH. Moreover, using the 2θ corresponding to the peak derived from the LDH-like compound in the X-ray diffraction enables determination of the interlayer distance of the layered crystal structure according to the Bragg formula. The interlayer distance of the layered crystal structure constituting the LDH-like compound determined in such a way is typically 0.883 to 1.8 nm and more typically 0.883 to 1.3 nm.

The LDH separator according to the aspect (a) above has an atomic ratio of Mg/(Mg+Ti+Y+Al) in the LDH-like compound of preferably 0.03 to 0.25 and more preferably to 0.2, as determined by energy dispersive X-ray spectroscopy (EDS). Further, the atomic ratio of Ti/(Mg+Ti+Y+Al) in the LDH-like compound is preferably 0.40 to and more preferably 0.47 to 0.94. Furthermore, the atomic ratio of Y/(Mg+Ti+Y+Al) in the LDH-like compound is preferably 0 to 0.45 and more preferably 0 to 0.37. In addition, the atomic ratio of Al/(Mg+Ti+Y+Al) in the LDH-like compound is preferably 0 to 0.05 and more preferably 0 to 0.03. The ratios within the above ranges render alkali resistance more excellent and make it possible to more effectively achieve an inhibition effect of short circuits caused by zinc dendrites (i.e., dendrite resistance). By the way, an LDH, which has been conventionally known for an LDH separator, can be represented by the basic composition with the general formula: M²⁺₁₋ₓM³⁺ₓ(OH)₂A^{n-x/n}·mH₂O wherein in the formula, M²⁺ is a divalent cation, M³⁺ is a trivalent cation, and Aⁿ⁻ is an n-valent anion, n is an integer of 1 or more, x is 0.1 to 0.4, and m is 0 or more. The above atomic ratios in the LDH-like compound, on the contrary, generally deviate from those of the above general formula of LDH. Therefore, it can be deemed that the LDH-like compound in the present aspect generally has a composition ratio (atomic ratio) that is different from that of the conventional LDH. Incidentally, EDS analysis is preferably carried out with an EDS analyzer (for example, an X-act manufactured by Oxford Instruments) by 1) capturing an image at an accelerating voltage of 20 kV and a magnification of 5,000 times, 2) carrying out a three-point analysis at approximately 5 μm intervals in a point analysis mode, 3) repeating the above 1) and 2) once more, and 4) calculating an average value of a total of 6 points.

According to another preferred aspect (b) of the present invention, the LDH-like compound can be hydroxide and/or oxide with a layered crystal structure containing (i) Ti, Y, and optionally Al and/or Mg, and (ii) additive element M. Thus, a typical LDH-like compound is complex hydroxide and/or complex oxide of Ti, Y, additive element M, optionally Al, and optionally Mg. Additive element M is In, Bi, Ca, Sr, Ba or combinations thereof. The above elements may be replaced by other elements or ions to the extent that the basic characteristics of the LDH-like compound are not impaired; however, the LDH-like compound is preferably free of Ni.

The LDH separator according to the aspect (b) above preferably has an atomic ratio of Ti/(Mg+Al+Ti+Y+M) in the LDH-like compound of 0.50 to 0.85 and more preferably 0.56 to 0.81, as determined by energy dispersive X-ray spectroscopy (EDS). The atomic ratio of Y/(Mg+Al+Ti+Y+M) in the LDH-like compound is preferably 0.03 to 0.20 and more preferably 0.07 to 0.15. The atomic ratio of M/(Mg+Al+Ti+Y+M) in the LDH-like compound is preferably 0.03 to 0.35 and more preferably 0.03 to 0.32. The atomic ratio of Mg/(Mg+Al+Ti+Y+M) in the LDH-like compound is preferably 0 to 0.10 and more preferably 0 to 0.02. In addition, the atomic ratio of Al/(Mg+Al+Ti+Y+M) in the LDH-like compound is preferably 0 to 0.05 and more preferably 0 to 0.04. The ratios within the above ranges render the alkali resistance more excellent and make it possible to more effectively achieve an inhibition effect of short circuits caused by zinc dendrites (i.e., dendrite resistance). By the way, an LDH, which has been conventionally known regarding a LDH separator, can be represented by a basic composition with the general formula: M²⁺₁₋ₓM³⁺ₓ(OH)₂Aⁿ⁻_{x/n}·mH₂O wherein in the formula, M²⁺ is a divalent cation, M³⁺ is a trivalent cation, and Aⁿ⁻ is an n-valent anion, n is an integer of 1 or more, x is 0.1 to 0.4, and m is 0 or more. The above atomic ratios in the LDH-like compound, on the contrary, generally deviate from those of the above general formula of LDH. Therefore, it can be deemed that the LDH-like compound in the present aspect generally has a composition ratio (atomic ratio) that is different from that of the conventional LDH. Incidentally, EDS analysis is preferably carried out with an EDS analyzer (for example, an X-act manufactured by Oxford Instruments) by 1) capturing an image at an accelerating voltage of 20 kV and a magnification of 5,000 times, 2) carrying out a three-point analysis at approximately 5 μm intervals in a point analysis mode, 3) repeating the above 1) and 2) once more, and 4) calculating an average value of a total of 6 points.

According to yet another preferred aspect (c) of the present invention, the LDH-like compound can be hydroxide and/or oxide with a layered crystal structure containing Mg, Ti, Y, and optionally Al and/or In, wherein the LDH-like compound is present in the form of a mixture with In(OH)₃. The LDH-like compound of this aspect is hydroxide and/or oxide with a layered crystal structure containing Mg, Ti, Y, and optionally Al and/or In. Thus, a typical LDH-like compound is complex hydroxide and/or complex oxide of Mg, Ti, Y, optionally Al, and optionally In. It is to be noted that In that can be contained in the LDH-like compound may be not only In that is intended to be added to the LDH-like compound, but also In that is unavoidably incorporated into the LDH-like compound derived from the formation of In(OH)₃, or the like. The above elements can be replaced by other elements or ions to the extent that the basic characteristics of the LDH-like compound are not impaired; however, the LDH-like compound is preferably free of Ni. By the way, an LDH, which has been conventionally known regarding a LDH separator, can be represented by a basic composition with the general formula: M²⁺₁₋ₓM³⁺ₓ(OH)₂Aⁿ⁻_{x/n}·mH₂O wherein in the formula, M²⁺ is a divalent cation, M³⁺ is a trivalent cation, and Aⁿ⁻ is an n-valent anion, n is an integer of 1 or more, x is 0.1 to 0.4, and m is 0 or more. The above atomic ratios in the LDH-like compound, on the contrary, generally deviate from those of the above general formula of LDH. Therefore, it can be deemed that the LDH-like compound in the present aspect generally has a composition ratio (atomic ratio) that is different from that of a conventional LDH.

The mixture according to the aforementioned aspect (c) contains not only the LDH-like compound but also In(OH)₃ (typically composed of the LDH-like compound and In(OH)₃). Containing In(OH)₃ in the mixture enables effective improvement in the alkali resistance and dendrite resistance of an LDH separator. The content proportion of In(OH)₃ in the mixture is preferably an amount that can improve the alkali resistance and dendrite resistance without impairing hydroxide ion conductivity of an LDH separator, and is not particularly limited. In(OH)₃ may be such that it has a cubic crystalline structure and also has a configuration in which the crystalline of In(OH)₃ is surrounded by the LDH-like compound. The In(OH)₃ can be identified by X-ray diffraction.

### EXAMPLES

The present invention will be described in more detail with reference to the following Examples.

### Examples 1 to 4

(1) Preparation of Positive Electrode

A paste-type nickel hydroxide positive electrode (capacity density: about 700 mAh/cm 3) was prepared.

(2) Fabrication of Negative Electrode

Various raw material powders shown below were prepared.
ZnO powder (manufactured by Seido Chemical Industry Co., Ltd., JIS Standard Class 1 grade, average particle size D50: 0.2 μm)
Metallic Zn powder (Bi and In doped, Bi: 1,000 ppm by weight, In: 1,000 ppm by weight, average particle size D50: 100 μm, manufactured by Mitsui Mining & Smelting Co., Ltd.)

To 100 parts by weight of ZnO powder were added 5 parts by weight of metallic Zn powder and further added 1.26 parts by weight of a polytetrafluoroethylene (PTFE) dispersion aqueous solution (manufactured by Daikin Industries, Ltd., solid content: 60%) in terms of solid content, and the mixture was kneaded together with propylene glycol. The resulting kneaded product was rolled by a roll press to obtain a plurality of negative electrode active material sheets with different thicknesses. The negative electrode active material sheets with different thicknesses were each then pressed onto both surfaces of a copper expanded metal treated with tin plating to obtain a negative electrode with different thickness ratios of negative electrode active material layers.

(3) Preparation of Electrolytic Solution

Ion-exchanged water was added to a 48% potassium hydroxide aqueous solution (manufactured by Kanto Chemical Co., Inc., special grade) to adjust the KOH concentration to 5.4 mol %, and then zinc oxide was dissolved at 0.42 mol/L by heating and stirring to obtain an electrolytic solution.

(4) Fabrication of Evaluation Cell

The positive electrode and the negative electrode were each wrapped with a nonwoven fabric, and each welded with a current extraction terminal. The positive electrode and the negative electrode thus fabricated were opposed to each other with the LDH separator interposed therebetween, sandwiched by a laminated film provided with a current extraction port, and the laminated film was heat-sealed on three sides thereof. The electrolytic solution was added to the obtained cell container with the upper side being opened, and was sufficiently permeated into the positive electrode and the negative electrode by vacuum evacuation, etc. Thereafter the remaining one side of the laminated film was also heat-sealed to form a simply sealed cell.

(5) Evaluation

Chemical conversion was carried out on the simply sealed cell with 0.1C charge and 0.2C discharge by using a charge/discharge apparatus (TOSCAT3100 manufactured by Toyo System Co., Ltd.). Then, a 1C charge/discharge cycle was carried out. Repeated charge/discharge cycles were carried out under the same conditions, and the number of charge/discharge cycles until a discharging capacity decreased to 70% of the discharging capacity of the first cycle of the prototype battery was recorded. The number of charge/discharge cycles for each Example is shown in Table 1 as a relative value when the number of charge/discharge cycles in Example 1 is set to 1.0, along with evaluation results based on the following criteria:

<Evaluation Criteria>

Evaluation A: The number of charge/discharge cycles (relative value with respect to the number of cycles in Example 1) is 2.0 or more.

Evaluation B: The number of charge/discharge cycles (relative value with respect to the number of cycles in Example 1) is 1.5 or more and less than 2.0.

Evaluation C: The number of charge/discharge cycles (relative value with respect to the number of cycles in Example 1) is 1.2 or more and less than 1.5.

Evaluation D: The number of charge/discharge cycles (relative value with respect to the number of cycles in Example 1) is less than 1.2.

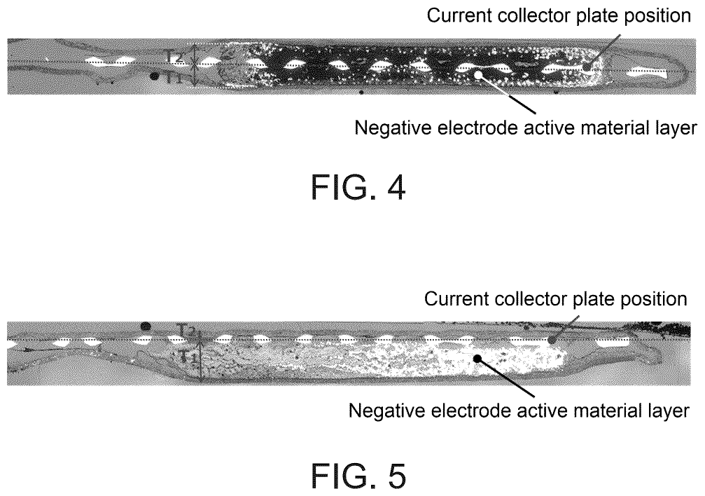

FIG. 4 shows the cross-sectional photograph of the negative electrode fabricated in Example 1 (comparison) (after charge/discharge evaluation), while FIG. 5 shows the cross-sectional photograph of the negative electrode fabricated in Example 4 (after charge/discharge evaluation). From the cross-section of the negative electrode in each Example, a reference plane was set through the center of the negative electrode current collector plate in the thickness direction, and each distance from both sides (outermost surface) of the negative electrode active material layer to the reference plane was measured to then calculate thickness T₁, thickness T₂, and the ratio T₂/T₁, respectively. The results were as shown in Table 1.

TABLE 1

| | Thickness of negative | | | Number of charge/ | |
|---|---|---|---|---|---|
| | electrode active material layer | | | discharge cycles | Charge/ |
| | Thickness | Thickness | | (relative value with respect to the | discharge |
| | T₁ (mm) | T₂ (mm) | T₂/T₁ | number of cycles in Example 1) | evaluation |
| Example 1* | 0.35 | 0.35 | 1.0 | 1.0 | D |
| Example 2 | 0.47 | 0.23 | 0.5 | 1.2 | C |
| Example 3 | 0.58 | 0.12 | 0.2 | 1.7 | B |
| Example 4 | 0.64 | 0.06 | 0.1 | 2.0 | A |

*denotes Comparative Example.

What is claimed is:

1. A negative electrode for use in a zinc secondary battery, comprising:
a negative electrode active material layer comprising at least one selected from the group consisting of zinc, zinc oxide, a zinc alloy, and a zinc compound, and having a first surface and a second surface,
a negative electrode current collector plate embedded in the negative electrode active material layer parallel to the negative electrode active material layer,
wherein the first surface is more remote from the negative electrode current collector plate than the second surface, whereby the center of the negative electrode active material layer in a thickness direction thereof is deviated from a reference plane passing through the center of the negative electrode current collector plate in a thickness direction thereof, and
wherein a ratio of a thickness T₂ defined as a distance between the second surface and the reference plane to a thickness T₁, defined as a distance between the first surface and the reference plane, T₂/T₁, is greater than 0 and 0.5 or less.

2. The negative electrode according to claim 1, wherein the negative electrode current collector plate is at least one selected from the group consisting of an expanded metal, a punching metal, and a metal mesh.

3. The negative electrode according to claim 1, wherein the ratio T₂/T₁ is greater than 0 and 0.2 or less.

4. The negative electrode according to claim 1, wherein a difference between the T₁ and the T₂ is 0.01 mm or more.

5. The negative electrode according to claim 1, wherein the T₂ is 0.01 to 1.0 mm.

6. A zinc secondary battery comprising
a positive electrode comprising a positive electrode active material layer and a positive electrode current collector,
the negative electrode according to claim 1,
a hydroxide ion conductive separator separating the positive electrode from the negative electrode so as to be capable of conducting hydroxide ions therethrough,
an electrolytic solution;
wherein the negative electrode is disposed so that the second surface is a side closer to the hydroxide ion conductive separator.

7. The zinc secondary battery according to claim 6, wherein the hydroxide ion conductive separator is an LDH separator comprising a layered double hydroxide (LDH) and/or an LDH-like compound.

8. The zinc secondary battery according to claim 7, wherein the LDH separator further comprises a porous substrate, and wherein the LDH and/or the LDH-like compound is composited with the porous substrate in a form of being filled in pores of the porous substrate.

9. The zinc secondary battery according to claim 8, wherein the porous substrate is made of a polymeric material.

10. The zinc secondary battery according to claim 6, wherein the positive electrode active material layer comprises nickel hydroxide and/or nickel oxyhydroxide, whereby the zinc secondary battery forms a nickel-zinc secondary battery.

11. The zinc secondary battery according to claim 6, wherein the positive electrode active material layer is an air electrode layer, whereby the zinc secondary battery forms an air-zinc secondary battery.
